(19) United States
(12) Patent Application Publication
(10) Pub. No.: US 2003/0190129 A1
(43) Pub. Date: Oct. 9, 2003

(54) Optical waveguide fibre

(76) Inventors: Ian Bassett, New South Wales (AU); Simon Fleming, New South Wales (AU); Mark Sceats, New South Wales (AU); Martijn Van Eijkelenborg, New South Wales (AU)

Correspondence Address: BANNER & WITCOFF, 1001 G STREET N W, SUITE 1100, WASHINGTON, DC, 20001, US

(21) Appl. No.: 10/362,452

(22) PCT Filed: Jul. 20, 2001
(86) PCT No.: PCT/AU01/00890

(51) Int. Cl. G02B 6/20

(52) U.S. Cl. 385/125

(57) ABSTRACT

An optical fibre (1) having at least one longitudinally extending light guiding core region (11), a longitudinally extending core-surrounding region (12), and a plurality of light confining elements (15, 16, 17, 18), such as, for example, channel-like holes, located within the core-surrounding region (12). The light confining elements (15, 16, 17, 18) extend in the longitudinal direction of the core region and are located geometrically in zones that surround the core region. The aggregate cross-sectional area defined by the light confining elements within the respective zones increases with increasing radial distance of the zones from the core region. A preform for use in manufacture of the optical fibre is also defined.

### FIELD IF THE INVENTION

This invention relates to an optical waveguide fibre that is formed in a manner to exhibit low bending loss. The invention has particular application to the class of optical fibres that are known as photonic crystal fibres (PCF's) or holey fibres and the invention is hereinafter described in the context of that class of fibre. However, it will be understood that the invention does have broader application.

### BACKGROUND OF THE INVENTION

In a photonic crystal fibre, light is guided through a core region of the fibre by light guiding holes that are disposed geometrically arround the core region and extend in the longitudinal direction of the core region for the length of the fibre. Photonic crystal fibres exhibit properties that are not available in conventional fibre design. For example, it has been demonstrated that silica-air photonic crystal fibre can be formed to exhibit single mode guiding independently of the transverse optical intensity profile (“spot size”) and wavelength.

For many applications it is desirable that single mode photonic crystal fibre be formed to provide a large spot size, to allow for high power transmission without concomitant non-linear effects, to facilitate splicing and to facilitate in/out coupling of light. However, a significant problem that is encountered with photonic crystal fibre, especially when the fibre is designed to exhibit a large spot size, is that bending losses are very large, even when the fibre is bent around what might otherwise be considered to be a modest radius of curvature. Thus, it can be shown that, in the case of a photonic crystal fibre having a conventional structure, the critical bending radius increases with the third power of the spot size.

Mechanical bending of an optical fibre effectively modifies the refractive index profile of the fibre. That is, mechanical bending exerts strain on the fibre material, causing the material on the inside of the neutral axis of the bend to be subjected to compressive stress and causing the material on the outside of the neutral access to be subjected to tensile stress. These conditions induce a change in the refractive index profile as a consequence of the elasto-optic effect and, at a certain radius of curvature, this stress-induced refractive index change reaches the same order of magnitude as the refractive index difference between the core and core-surrounding regions in'the unbent fibre. This is the critical radius and it represents the minimum allowed bending radius below which light will not properly be confined to the core region of the fibre, resulting in large losses.

To achieve a single mode propagation in a photonic crystal fibre, especially in the case of a large spot size fibre, a very small difference in the effective refractive index of the core and the cladding is required. This results in the fibre being very vulnerable to bending losses, whether caused by bending induced stress or by the geometric change created by a bend.

### SUMMARY OF THE INVENTION

A fibre design that will minimise the above stated problem and provide a fibre that exhibits a relatively low bending loss.

Broadly defined, the present invention provides an optical fibre having:

(a) at least one longitudinally extending light guiding core region,

(b) a longitudinally extending core-surrounding region, and

(c) a plurality of light confining elements located within the core-surrounding region.

The light confining elements extend in the longitudinal direction of the core region and are located geometrically in zones that surround the core region. Also, at least a majority of the light confining elements have a refractive index that is less than that of the material of which the core-surrounding region is composed, and the aggregate cross-sectional area defined by the light confining elements within the respective zones increases with increasing radial distance of the zones from the core region.

As a consequence of the aggregate cross-sectional area of the light confining elements within the respective zones increasing with radial distance from the core region, the core-surrounding region will exhibit an average refractive index throughout its volume that decreases with increasing radial distance from the core region. However, the decrease in the average refractive index need not be linear and, thus, the aggregate cross-sectional area of the light confining elements in adjacent ones of the zones may vary positively and negatively provided that an average increase occurs with radial distance from the core region.

The invention also provides a preform used in the manufacture of the above-defined optical waveguide, the preform having

(a) at least one longitudinally extending core region,

(b) a longitudinally extending core-surrounding region, and

(c) a plurality of elements located within the core-surrounding region, the elements extending in the longitudinal direction of the core region and being located geometrically in zones that surround the core region.

At least a majority of the elements have a refractive index that is less than that of the material of which the core-surrounding region is composed, and the aggregate cross-sectional area defined by the elements within the respective zones increases with increasing radial distance of the zones from the core region.

### PREFERRED FEATURES OF THE INVENTION

In optical fibre, in order that the aggregate cross-sectional area of the light confining elements within the respective zones might increase with increasing radial distance of the zones from the core region, the number of light confining elements within the respective zones may increase with radial distance of the zones from the core region. However, it is preferred that the cross-sectional area of the individual light confining elements within the respective zones will increase with radial distance of the zones from the core region.

The light confining elements within the core-surrounding region may be positioned geometrically so as to provide for non-uniform or, preferably, uniform reduction in the effective refractive index with increasing radial distance from the core region. In the former, less preferred, case the reduction in refractive index may be arranged to vary with different radial angles from the core.

The core-surrounding region may be is composed of a material that is the same as that of which the core region is composed of and the invention is hereinafter described in this context. However, it will be understood the core and core-surrounding regions may be composed of different materials having different refractive indexes, for example, doped silica in the case of the core-region and undoped silica in the case of the core-surrounding region. Also, it will be further understood that, when the light confining elements are formed in a lattice-like structure, so as to create one or more photonic bandgap(s) in the core surrounding region, the core region may be formed as a hollow core or from a material that has a lower refractive index than that of the core-surrounding material.

The optical fibre preferably has a single longitudinally extending light guiding core region, and the invention is hereinafter described in this context. However, it will be appreciated that multi-core structures may be formed with the plural cores sharing a common core-surrounding region.

The light confining elements preferably comprise longitudinally extending channel-like holes which, depending upon specific requirements, may be evacuated, be occupied by air or be filled with other (liquid or gaseous) fluids. However, some or all of the light confining elements may comprise filaments of solid material such as glass or a polymeric material that has a refractive index less than that of the core-surrounding region.

The light confining elements when in the form of channel-like holes, may have any cross-sectional shape. They may be circular in cross-section, although some or all of the holes may have elliptical cross-sections or arcuate cross-sections. As a further alternative, some or all of the holes may have polygonal cross-sections.

The light confining elements preferably are distributed about the core region, that is within the respective zones, to surround the core region in a spatially uniform or symmetrical manner. For example, the light confining elements may be distributed around a plurality of circles (that define the respective zones) which are all concentric with the axis of the core region. As a further alternative, the light confining elements as seen in cross-section may be distributed geometrically in regular arrays, for example, in polygonal honeycomb-like arrays or, as indicated previously, in lattice like arrays.

The light confining elements most preferably are distributed about the core region, within the respective zones, in circularly concentric or polygonally concentric arrays. The invention will be more fully understood from the following description of alternative forms of optical fibre that embodied the invention. The description is provided with reference to the accompanying drawings.

### BRIEF DESCRIPTION OF THE DRAWINGS

In the drawings, FIGS. 1 to 4 show diagrammatic representations of the transverse cross-section of optical fibres that incorporate different embodiments of the invention.

### DETAILED DESCRIPTION OF THE INVENTION

As illustrated in FIG. 1, the optical fibre 10 comprises a longitudinally extending light guiding core region 11 and a longitudinally extending core-surrounding region 12. The core region 11 is indicated as being defined by the broken circle 13 for convenience of reference, but it will be understood that the core region 11 need not necessarily have any clearly defined outer margin.

In one form of the invention, the core region 11 and the core-surrounding region 12 are homogeneous in the sense that they are both formed from the same material without any interface between the two regions. Any optically transparent material may be employed in forming the core and core-surrounding regions, including doped silica and undoped silica.

A plurality of light confining elements 15, 16, 17 and 18 in the form of longitudinally extending channel-like holes is located within the core-surrounding region 12, and each of the light confining elements 15 to 18 extends for the full length of the optical fibre. The light confining elements are positioned geometrically in zones that surround the core region 11 and, as illustrated, are positioned uniformly in four circular zones that are concentric with the axis of the core region. However, it is to be understood that, depending upon the requirements of the fibre and the spot-shape required of guided light, the light confining elements 15 to 18 need not be positioned in a circularly symmetric or other symmetric manner.

The light confining elements 15 to 18 as formed will normally be occupied by air. However, they may be evacuated, be filled with another fluid or be constituted by filaments of a solid material such as silica, doped silica or a polymeric material, depending upon the optical properties required of the optical fibre.

Whatever their form, a majority of the light guiding elements 15 to 18 must exhibit a refractive index that is lower than that of the material from which the core-surrounding region 12 is formed, so that the core-surrounding region as a whole will exhibit an average refractive index throughout its volume that is less than that of the core region 11. Thus, the light confining elements function collectively to confine light to the core region of the optical fibre.

Each of the inner zone light guiding elements 15, when in the form of a channel-like hole, will normally have a diameter within the range of 0.1 μm to 10 μm, and adjacent elements 15 will normally have a centre spacing in the order of 2 μm to 20 μm, depending upon the size of each hole.

The first ring or zone of light confining elements 15 is constituted by channel-shaped holes having very small diameters, and the hole size increases in the subsequently larger (concentric) rings or zones of channel-like holes 16, 17 and 18. This provides the required weak index-difference guiding in the core region 11 of the fibre, ensuring single moded transmission, whilst the outer rings of the larger holes (which provide the larger index difference) protect against leakage when the fibre is bent.

In addition to the use of the arrangement shown in FIG. 1 to reduce bending losses, the shape and size of the channel-like air holes that constitute the light confining elements may be utilised to reduce mechanical stresses and, at the same time tailor index grading in the fibre material. The channel-like holes will normally be occupied by a medium (e.g. a vacuum, air or other gas) that has a much greater elasticity than the material that immediately surrounds the holes. Therefore, the mechanical stresses due to bending of the optical fibre will be relieved by the deformation of the holes, this reducing the stress induced refractive index changes in the fibre material and thus, further, the bending losses.

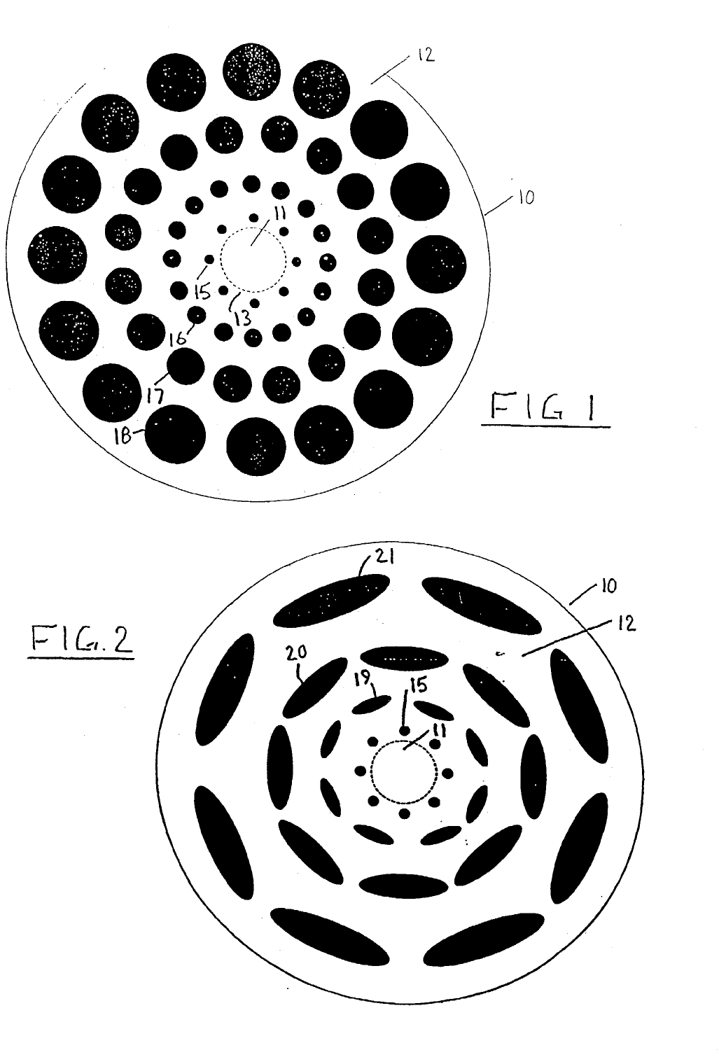

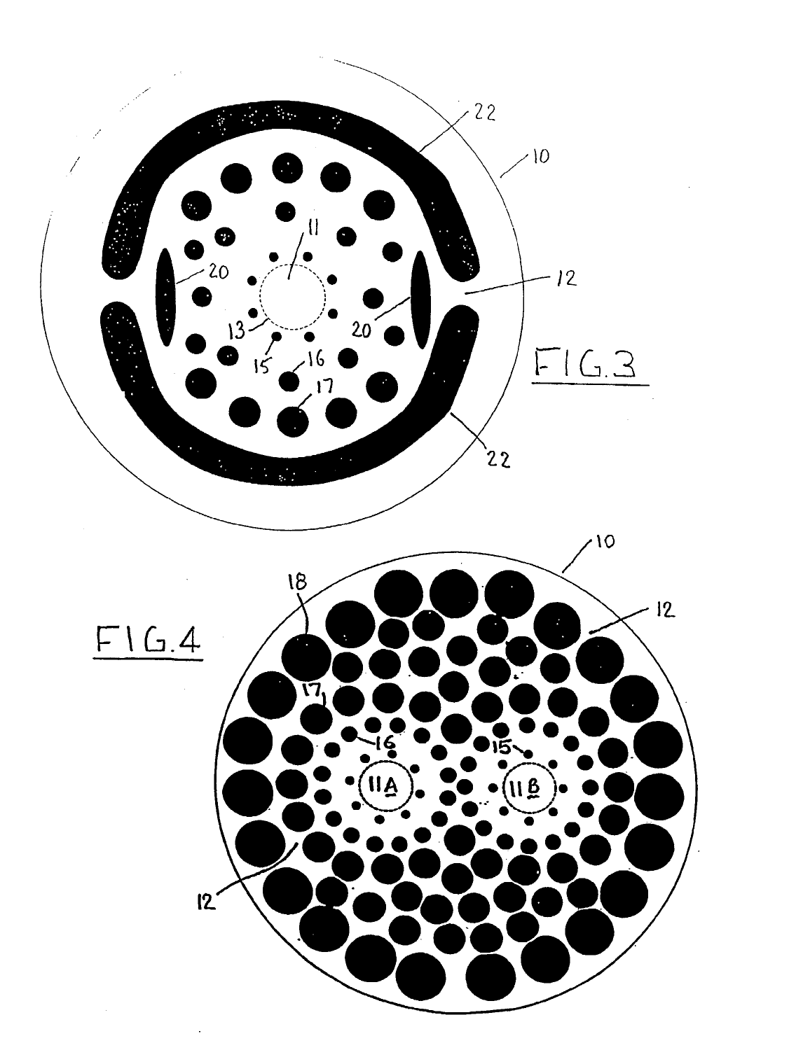

The optical fibres that are shown in cross-section in FIGS. 2 and 3 illustrate variations of that which is shown in FIG. 1 and provide the optical fibres with characteristics to meet differing requirements. In the case of the fibre shown in FIG. 2, an innermost ring of circular-section channel-form holes 15 is provided, but this is surrounded by concentric rings of elliptical-form channel-like holes 19, 20 and 21. However, the structure still exhibits circular symmetry.

In contrast to the arrangement shown in FIG. 2, that which is shown in FIG. 3 exhibits different symmetries about the X-X and Y-Y axes. In this case the core region 11 is surrounded by two concentric rings of light confining elements 15 and 16, with the outer ring 16 being in part surrounded by an incomplete ring of channel-like holes 17. Then, in addition to the provision of two elliptical holes 20, two arcuate-form channel-like holes 22 are provided within the core-surrounding region 12.

FIG. 4 shows a further optical fibre 10 which embodies the features of the invention and the arrangement illustrated has a superficial similarity with that which is shown in FIG. 1. However, in the case of the optical fibre as shown in FIG. 4, two core regions 11A and 11B are provided, each of which is surrounded by the core-surrounding region 12. Also, each of the core regions 11A and 11B is surrounded by inner rings of light guiding regions 15 and 16, and subsequent light guiding elements in the form of channel-like holes 17 and 18 are located within the common core surrounding region 12 and are shared by both of the core regions 11A and 11B.

The various optical fibres as described and illustrated in the various drawings may be formed in various ways. For example, they may be drawn from preforms that are fabricated from a single silica material or concentric regions of doped silica material.

Variations and modifications may be made in respect of the optical fibre in its various forms without departing from the scope of the invention as defined in the appended claims.

The claims defining the invention are as follows:

1. An optical fibre having:
(a) at least one longitudinally extending light guiding core region,
(b) a longitudinally extending core-surrounding region, and
(c) a plurality of light confining elements located within the core-surrounding region, the light confining elements extending in the longitudinal direction of the core region and being located geometrically in zones that surround the core region, at least a majority of the light confining elements having a refractive index that is less than that of the material of which the core-surrounding region is composed, and the aggregate cross-sectional area defined by the light confining elements within the respective zones increasing with increasing radial distance of the zones from the core region.

2. The optical fibre as claimed in claim 1 wherein the number of light confining elements within the respective zones increases with radial distance of the zones from the core region.

3. The optical fibre as claimed in claim 1 wherein the cross-sectional area of the individual light confining elements within the respective zones increases with radial distance of the zones from the core region.

4. The optical fibre as claimed in any one of the preceding claims wherein the light confining elements within the core-surrounding region are positioned geometrically so as to provide for linear reduction in effective refractive index with increasing radial distance from the core region.

5. The optical fibre as claimed any one of the preceding claims wherein the core-surrounding region is composed of a material which is the same as that of which the core region is composed.

6. The optical fibre as claimed in any one of the claims 1 to 4 wherein the materials from which the core and the core-surrounding regions are formed are different.

7. The optical fibre as claimed in claimed 5 or 6 wherein the core region is formed at least in part as a hollow core.

8. The optical fibre as claimed in any one of the preceding claims wherein the light confining elements comprise longitudinally extending channel-like holes.

9. The optical fibre as claimed in any one of the preceding claims wherein the light confining elements are distributed about the core region in a symmetrical manner.

10. The optical fibre as claimed in any one of the preceding claims wherein the light confining elements are distributed around a plurality of circles which are all concentric with the axis of the core region.

11. The optical fibre as claimed in any one of the preceding claims wherein the light confining elements as seen in cross-section are distributed geometrically in regular arrays.

12. The optical fibre as claimed in claim 11 wherein the light confining elements as seen in a cross-section are distributed in polygonal honeycomb-like arrays.

13. The optical fibre as claimed in any one of the preceding claims wherein the light confining elements are distributed about the core region, within the respective zones, in circularly concentric or polygonally concentric arrays.

14. A preform used in the manufacture of the above-defined optical waveguide, the preform having
(a) at least one longitudinally extending core region,
(b) a longitudinally extending core-surrounding region, and a plurality of elements located within the core-surrounding region, the elements extending in the longitudinal direction of the core region and being located geometrically in zones that surround the core region, at least a majority of the elements having a refractive index that is less than that of the material of which the core-surrounding region is composed, and the aggregate cross-sectional area defined by the elements within the respective zones increases with increasing radial distance of the zones from the core region.
